(19) United States
(12) Patent Application Publication
(10) Pub. No.: US 2007/0005239 A1
(43) Pub. Date: Jan. 4, 2007

(54) Method and system for initialization in distributed navigation

(76) Inventors: Franck Kirouchenaradje, Phoenix, AZ (US); Juan C. Uribe, Chandler, AZ (US)

Correspondence Address: MOTOROLA INC, 600 NORTH US HIGHWAY 45, ROOM AS437, LIBERTYVILLE, IL, 60048-5343, US

(21) Appl. No.: 11/170,650

(22) Filed: Jun. 29, 2005

(51) Int. Cl. G01C 21/30

(52) U.S. Cl. 701/209

(57) ABSTRACT

Disclosed is a distributed navigation system, method and apparatus including a junction sieve generator (106) for generating a junction sieve based on a navigation route request (102), the user's first position (104) and a configuration area (201), the junction sieve including significant crossings (204, 206, 208, 210, 212, 214, 216, 218 and 220) within the configuration area and having maneuver direction information. The route request (102) and the first user's first position (104) are provided to a central unit (304) by the client (302).

### FIELD OF THE INVENTION

This invention relates to distributed navigation systems and in particular to navigation data.

### BACKGROUND

In distributed navigation systems, a global positioning system (GPS) is installed onboard an automobile. The client's onboard distributed navigation device includes a transmitter, receiver and processor that may be in communication with a central unit and may be mounted on the dash of the automobile or may be handheld, depending on the model. Routing information may be provided to the client (user) on a display device, and/or via oral instructions.

The central unit or remote server receives navigation route requests from the client and computes and transmits routing information to the client. The central unit includes a client location module that receives a client's position in longitude, latitude and possibly altitude from a client's onboard GPS receiver. The accuracy of GPS is approximately ten to twenty feet.

The maps processed in a distributed navigator system include large amounts of data. The updating of the voluminous map and location information is performed centrally. The map information includes average travel speed classifications, one way streets, names and road numbers of all streets, expressway ramp details, and other travel information elements. Furthermore, maps may contain points of interest including restaurants, hotels, gas stations, garages, parks, hospitals including their telephone numbers, hours of operation and possibly advertisements. Also, traffic reports and advice may be incorporated into the information sent to the client. Map data is constantly updated regarding road closures and new road construction.

In a distributed navigation system, the heavy computation such as route finding is performed by the central unit based on a route request by the client, freeing up the client device for processing in real time routines such as tracking. A route is computed and downloaded upon a route request transmitted to the remote server by the client.

A distributed navigation system architecture provides two advantages over autonomous navigation systems. In a distributed navigation system the centralized map database requires no maintenance by the client and since the cost of maintenance is spread over all clients, there is low cost to an individual client. However, there may be limited data availability on the client side. That is, when the client requests a route, the server's response is limited to the map data along the main route that has been computed in order to have acceptable response times. If the GPS data is inaccurate, the requested guidance cannot start if only a single route is provided. If the vehicle happens to move away from the planned single route between the time the route request has been initiated and the time the response has been received, the requested guidance cannot start. Accordingly, the client may need to make repeated route requests. Since, as mentioned above, extended amounts of information may be transmitted in a single transmission to the client, the data downloading time in each instance may be substantial.

### BRIEF DESCRIPTION OF THE DRAWINGS

FIG. 1 is a flowchart depicting steps by the central unit and the client device;

FIG. 2 depicts an example configuration area as described herein;

FIG. 3 is a signal diagram depicting a sequence of events according to the distributed navigation system described herein; and

FIG. 4 is a flowchart that show a decision point in the tracking and matching process.

### DETAILED DESCRIPTION OF THE INVENTION

A distributed navigation system, method and apparatus are described including a junction sieve generator for generating a junction sieve based on a navigation route request, the user's first position, and the configuration area. The junction sieve includes significant crossings within the configuration area, and has guidance information. The route request and the user's first position are provided to a central unit by the client.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

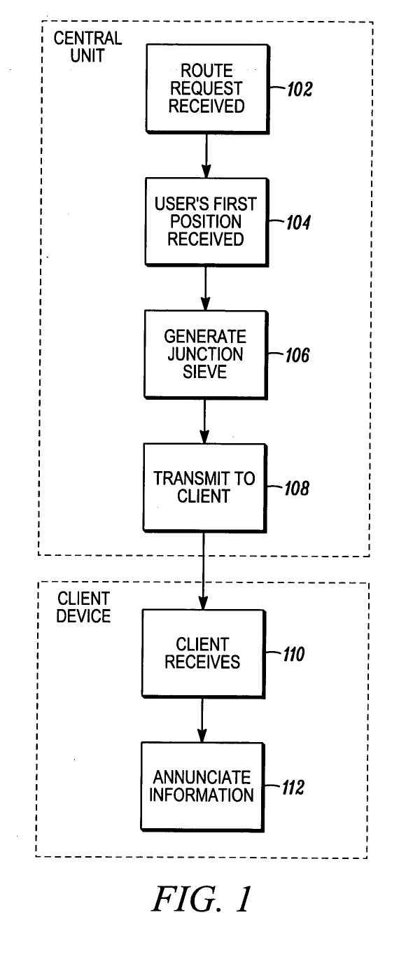

FIG. 1 is a flowchart of a method according to an embodiment depicting steps in the central unit and the in client device. A client of the disclosed distributed navigation system transmits a route request to a central unit that is remote to the client. The remote central unit or server may be a plurality of discreet or individual components in communication with one another in a wireless or wired manner. The use of the term central unit is for convenience and is not intended to limit the configuration of the central unit. The central unit may include components such as a client location module (which may receive GPS data from the client device), a transmitter and receiver, a processor, and a database. In general, the transmission of the route request from the client is performed wirelessly over any type of wireless network. The route request is received by the central unit from the client 102.

The user's first position is also received 104. The GPS data on the user's first position may be separate or part of the route request. While GPS is a common manner in which to provide a client's position, such information may be manually or otherwise entered as well. Based on the navigation route request and the user's first position, the central unit generates a junction sieve 106 within the configuration area, the junction sieve including significant crossings and guidance information at the crossings.

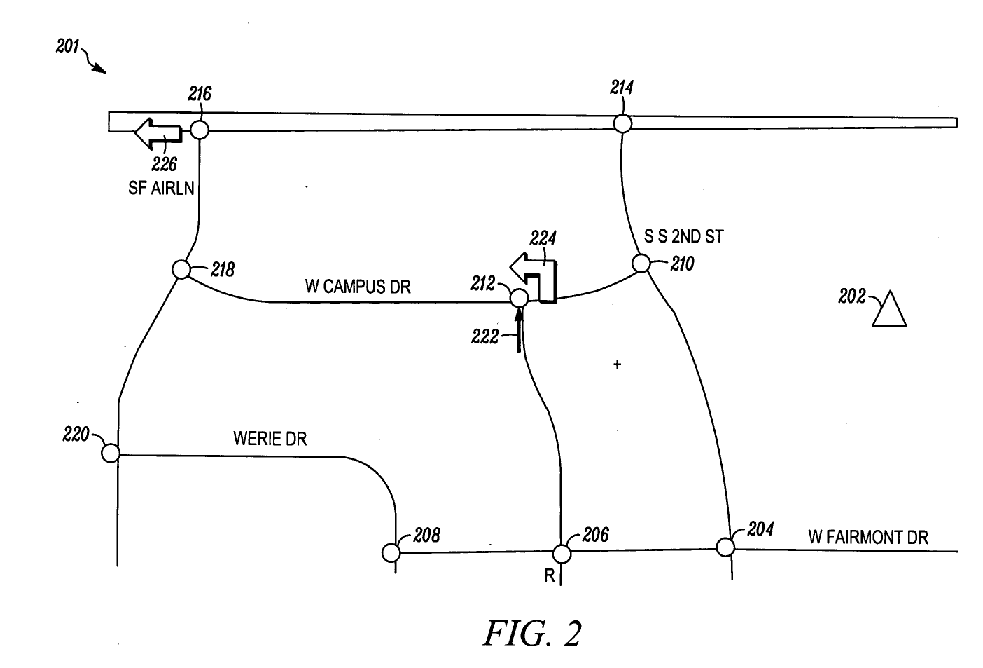

The central unit generates the junction sieve from tables, calculations and real-time data. The content of the junction sieve is described with reference to FIG. 2. The junction sieve is transmitted to the client 108. The client receives the junction sieve 110 and the information provided by the junction sieve is used to provide guidance 112 via oral communication and/or a visual display by the client device.

In the configuration area depicted in FIG. 2, the crossings are of interest from a junction sieve point of view can be provided, filtering out any other map information such as segments, hence the terminology, junction sieve. The terms node, intersection, crossing and junction are used interchangeably. It will be understood that the phrase “junction sieve” is a term directed to describing the information provided to the client device by the central unit. The client device can use this information to guide the user according to the distributed navigation described method and system. It is understood that the junction sieve diagram of FIG. 2 is meant in the context of this disclosure as support material in understanding the junction sieve method and system. FIG. 2 includes more information than that which may be included in the actual download of information from server to client device.

The information displayed to the user in a navigation system, whether it is autonomous, distributed, is an arrow that represents the maneuver and eventually with the distance to the maneuver. Advance systems may add certain features such as a three-dimensional arrow in perspective and a progress bar. In general, in a distributed system, the server sends to the client device the data required to display the appropriate arrow at the appropriate time.

As described herein, the client device receives minimal strategic data which includes guidance information at a plurality of significant crossings surrounding the client's first position. This provides sufficient information to guide the client onto an appropriate route for the client's final destination. The data may be as small as 64 bytes per junction but this number may vary greatly depending upon the bandwidth of the data download.

The central unit determines a configuration area 201, depicted in FIG. 2, centered on or including the current position of the vehicle provided to the central unit during the step 106 of FIG. 1. Then the central unit generates a junction sieve covering the configuration area. For each junction around the client, that is, within the configuration area, the junction sieve includes: the coordinates of the junction node in the map database; the bearings of the incoming segments; the maneuver to follow the route from each incoming segment; and the next node along the route.

Accordingly, the junction sieve provides a plurality of routes to the same destination. In FIG. 2, the client's position is indicated by a triangle 202. The client may be on-route or may be parked, for example in a parking lot when he/she sends the route request received 102 by the central unit. The client is provided information related to the significant crossings or nodes 204, 206, 208, 210, 212, 214, 216, 218 and 220.

The junction sieve delivered to the client device 106 includes of numeric and textural information that can be used for tracking and guidance. This information is not meant to be presented to the final user. Instead, the client device will use this information to generate appropriate audio and graphic output according to the device capabilities.

The data contained in the junction sieve corresponding to FIG. 2 is summarized in Table 1. Each row corresponds to one pair (junction, incoming segment) in the coverage area and includes the junction, the incoming heading and the associated maneuver. It is assumed that the user (driver) must go through the road designated by the arrow 226 to reach the final destination. Accordingly, Table 1 includes information to direct the client's maneuvers onto the desired route.

TABLE 1
Junction Sieve Data

| | | Incoming | |
|---|---|---|---|
| Instructions | Junction ID | Heading | Maneuver |
| 1 | 216 | 0 | TURN LEFT |
| 2 | 216 | 90 | MAKE A U TURN |
| 3 | 216 | 270 | CONTINUE AHEAD |
| 4 | 214 | 0 | TURN LEFT |
| 5 | 214 | 90 | MAKE A U TURN |
| 6 | 214 | 270 | CONTINUE AHEAD |
| 7 | 218 | 30 | CONTINUE AHEAD |
| 8 | 218 | 300 | TURN RIGHT |
| 9 | 218 | 210 | MAKE A U TURN |
| 10 | 212 | 0 | TURN LEFT |
| 11 | 212 | 90 | MAKE A U TURN |
| 12 | 212 | 270 | CONTINUE AHEAD |
| 13 | 210 | 65 | TURN LEFT |
| 14 | 210 | 330 | CONTINUE AHEAD |
| 15 | 210 | 150 | MAKE A U TURN |
| 16 | 220 | 0 | CONTINUE AHEAD |
| 17 | 220 | 270 | TURN RIGHT |
| 18 | 220 | 180 | MAKE A U TURN |
| 19 | 208 | 0 | CONTINUE AHEAD |
| 20 | 208 | 270 | TURN RIGHT |
| 21 | 208 | 180 | MAKE A U TURN |
| 22 | 206 | 0 | TURN LEFT |
| 23 | 206 | 270 | CONTINUE AHEAD |
| 24 | 206 | 180 | TURN RIGHT |
| 25 | 206 | 90 | MAKE A U TURN |
| 26 | 204 | 0 | CONTINUE AHEAD |
| 27 | 204 | 270 | TURN RIGHT |
| 28 | 204 | 180 | MAKE A U TURN |
| 29 | 204 | 90 | TURN LEFT |

In this way, the junction sieve contains high level data, such as maneuvers to follow the route from any junction in the sieve. As an illustration of maneuvers, two additional arrows are positioned in the graphic representation. Small arrow 222 with the incoming heading into the junction 212 and a large arrow 224 providing direction out of the crossing 212. Arrows 222 and 224 correspond to instruction 10 in Table 1.

Limited the data to the nodes minimizes the size of data sent over the wireless network. Accordingly, the information of the junction sieve of Table 1 is substantially less than that of a generic map. The high level information provided by the junction sieve is a meta-map not including line segments. In this way, the data feed from the central unit is substantially less than that of a generic map, and the speed at which the data feed may occur is substantially greater.

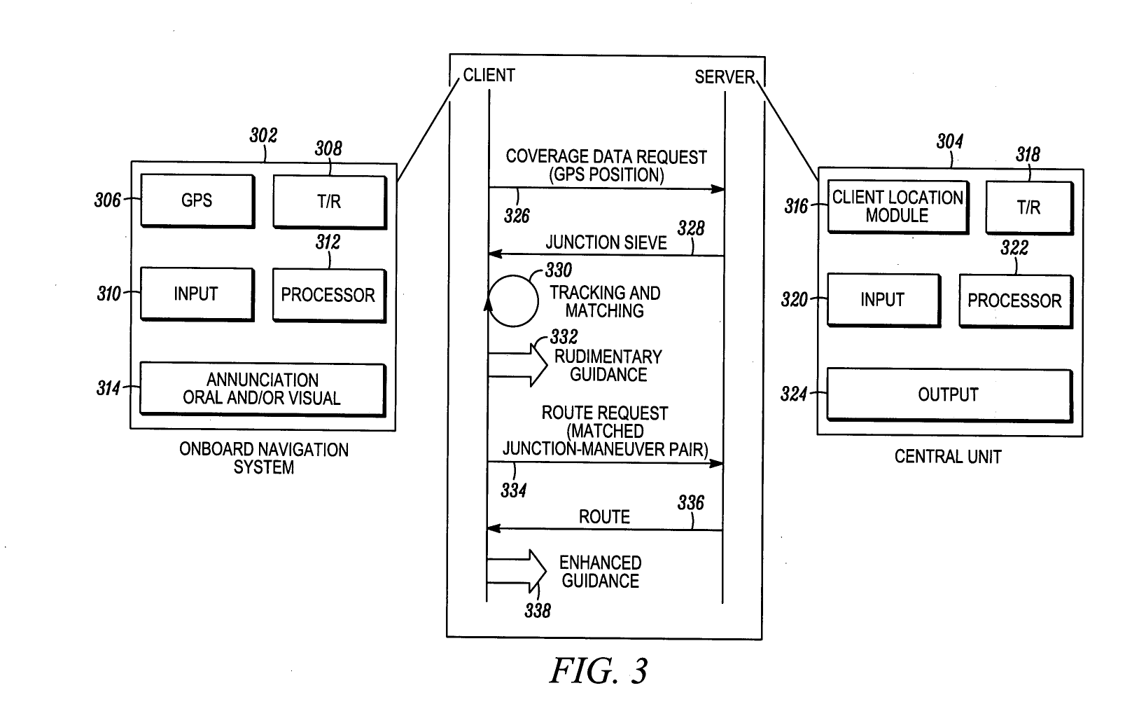

The junction sieve data can allow the client device to perform basic tracking and provide simple guidance, that is while approaching junctions, until the vehicle is on-route. In an operation performed by the client device 308, the client device confirms the on-route status by providing signals to the central unit indicating the node and incoming segment pair that was matched 303. The tracking and confirmation steps are transparent to the user. Since the data is organized per node rather than per segment, the matching algorithm (discussed with reference to FIG. 3) on the client side that processes the junction sieve data has less to process than a segment based map.

In a later step, the central unit sends the fully detailed route (enhanced route) starting from the matched pair to the final destination. Upon reception, the client device identifies its current position along the final route and switches to accurate tracking mode. Since the complete geometry is now available thru the segment data, the tracking becomes continuous and the guidance can be provided at any point along the route rather than at the proximity of junctions.

Now referring to FIG. 3, a signal diagram depicts a sequence of events according to the distributed navigation system described herein. Furthermore, the diagram also includes hardware components and/or software modules of the client's onboard navigation system 302 and the central unit 304. The client's onboard navigation system (including fixed and portable units) includes GPS device 306, a transmitter and receiver 308, an input device 310, a processor 312 and an annunciation device 314. The central unit 304, which may be discrete units as described above, includes a client location module 316, a transmitter and receiver 318, an input device 320, a processor 322 including a junction sieve generator and an output device 324. The junction sieve generator may include software modules and/or hardware devices that may be remote to one another, in communication with one another via wires or wireless technology, and may include one or more databases, real-time data feeds and computational capabilities.

As described with reference to FIG. 1, the client makes a route request to the central unit that may include the GPS position 326. In the initialization phase, the junction sieve 328 includes a set of significant routes starting from the closest junctions to the origin. The origin may be the current location of the client, or another location near the client location, if more convenient. The term “significant” is flexible. Here, significant routes and/or significant crossings are those that provide the client passage to a final destination depending upon the circumstances. There may be a limit to the size of the data feed. Other situations may be present such as a traffic accident that would make traveling across a large crossing difficult. In this instance, an otherwise unimportant crossing may be considered a significant crossing.

The meaning of the configuration area is also flexible. Circumstances may dictate the size or dimensions of the configuration area, e.g. depending upon the speed of the client, the distance from the beginning point to the end point, the traffic conditions and the weather conditions.

As the client moves, GPS information may be provided to the central unit. The GPS may monitor the client's position at various intervals or continuously. The tracking and matching algorithm 330 processes GPS information in conjunction with the junction sieve. Initialization according to rudimentary guidance is accordingly provided 332. As the client moves, two different conditions may occur. The client may stay within the configuration area or the client may move outside the configuration area.

If the client stays within the configuration area then the client device 302 or the central unit 304 resolves whether there is a matched junction-maneuver pair. It may be established at that point, or at a later matched junction-maneuver pair that the client has achieved the route. Automatically or manually, a new route request 334 for an enhance route is processed by the client and transmitted to the central unit 304. In that event, an enhance route is generated and transmitted to the client device 336. The enhanced guidance route 338 is annunciated to the user via the client device 314. The enhanced guidance route may be in the form of a generic map as described above.

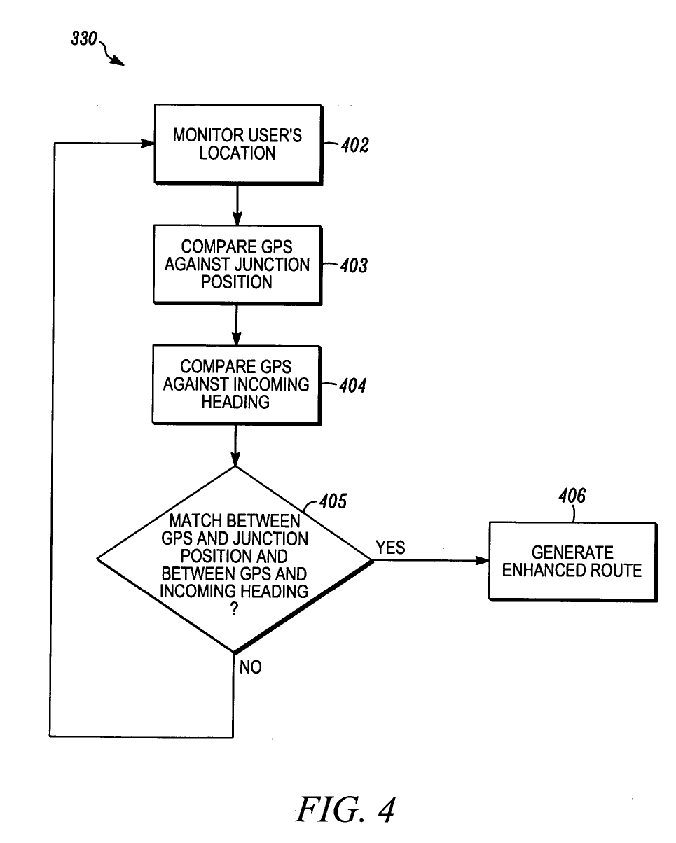

Turning to FIG. 4, the flowchart provides an example of a decision point in the tracking and matching process 330. The matching process is against the data in the current junction sieve. More specifically, the flowchart shows a comparison of coordinates derived from GSP signals (GPS) against junction positions and incoming headings, up to the point where there is a match. The user's position within the configuration is monitored 402. A comparison can be made between GPS and the user's junction position 403. A comparison can also be made against the incoming heading 404. If it is determined that there is a match between GPS and a junction position and between GPS and an incoming heading 405, an enhance route can be generated 405.

It is understood that while the described process and system avoids some of the complex problems in initializing a distributed navigation client it may also be practical in other situations, e.g. whenever an off-route correction is required, such as in a parking lot or when the client vehicle detours off a planned route.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A distributed navigation guidance method, comprising:
receiving a user's navigation route request;
receiving a user's position within a configuration area;
generating a junction sieve based on the navigation route request, the user's position and the configuration area, the junction sieve including significant crossings within the configuration and having maneuver direction information; and
transmitting the junction sieve to the user.

2. The method as recited in claim 1, comprising:
receiving the junction sieve; and
operating in accordance with the received junction sieve.

3. The method as recited in claim 2, comprising:
annunciating the junction sieve on an output device.

4. The method as recited in claim 3, wherein an output device is a graphic output device.

5. The method as recited in claim 3, wherein an output device is an audio output device.

6. The method as recited in claim 1, comprising:
monitoring user's position; and
determining whether the user's position is within the configuration area.

7. The method as recited in claim 6, comprising:
generating a new junction sieve if the user's position is outside the configuration area; and
transmitting the new junction sieve to the user.

8. The method as recited in claim 6, comprising:
generating an enhanced guidance route if the user's position is inside the configuration area; and
transmitting the enhance guidance route to the user.

9. The method as recited in claim 6, comprising:
generating a new junction sieve if the user's position is inside the configuration area; and
transmitting the new junction sieve to the user.

10. The method as recited in claim 2, wherein direction information provides direction at a crossing, the method comprising:
including arrows for each of the crossings to indicate the direction along a route within the configuration area.

11. A distributed navigation system, comprising:
a positioning unit for determining the first position of a land vehicle;
a receiver for receiving the position of the land vehicle within a configuration area and a route planning request;
a junction sieve generator for generating a junction sieve based on the navigation route request, the position of the land vehicle and the configuration area, the junction sieve including significant crossings within the configuration area and having maneuver direction information; and
a transmitter for transmitting to the land vehicle the junction sieve.

12. The system as recited in claim 11, further comprising:
a receiver associated with the land vehicle for receiving the junction sieve.

13. The system as recited in claim 11, further comprising a graphic display wherein guidance information is presented according to the land vehicle's position within the configuration area.

14. The system as recited in claim 11, further comprising an audio output wherein guidance information is annunciated according to the land vehicle's position within the configuration area.

15. The system as recited in claim 11, further comprising:
an enhanced route planner for planning a route based on a position of the land vehicle inside the configuration area wherein the enhanced route planner is for generating an enhanced guidance route.

16. The system as recited in claim 11, wherein the configuration area includes nodes adjacent the user's first position.

17. A distributed navigation guidance apparatus for generating a junction sieve based on a user's route planning request and a vehicle's first position, comprising:
a receiver for receiving the user's route planning request and the vehicle's first position within a configuration area;
a junction sieve generator for generating a junction sieve based on the route planning request, the first position of the land vehicle and the configuration area, the junction sieve including significant crossings within the configuration area and having maneuver direction information; and
a transmitter for transmitting the junction sieve.

18. The apparatus as recited in claim 17, wherein the apparatus is in communication with a navigation device comprising a receiver for receiving the junction sieve.

19. The apparatus as recited in claim 18, wherein the navigation device comprising an audio output device for annunciating the junction sieve.

20. The apparatus as recited in claim 18, wherein the navigation device comprising a graphic output device for displaying at least one significant crossing of the junction sieve.
